(19) United States
(12) Patent Application Publication
(10) Pub. No.: US 2023/0417455 A1
(43) Pub. Date: Dec. 28, 2023

(54) MODULAR SOLAR CONCENTRATOR

(71) Applicant: GREENETICA DISTRIBUTION S.R.L., Abano Terme (PD) (IT)

(72) Inventors: Antonio SICHIROLLO, Montebelluna (IT); Andrea BIASUTTI, PORDENONE (IT)

(21) Appl. No.: 18/252,275

(22) PCT Filed: Aug. 23, 2021
(86) PCT No.: PCT/IB2021/057722

§ 371 Date: May 9, 2023

(30) Foreign Application Priority Data
Nov. 17, 2020 (IT) 102020000027501

(51) Int. Cl. F24S 23/74; F24S 23/70

(52) U.S. Cl. CPC F24S 23/74; F24S 23/82

(57) ABSTRACT

Modular solar concentrator including first support defining a main axis transversal to ground, second support constrained to first support and including a first tubular element defining a rotation axis transversal to the main axis and two first flanges at first tubular element ends, a mirror defining a reflecting surface to focus solar rays, a receiver to acquire focused solar rays, sideboards each defining a concave profile and constraint area with a circular sector to allow constraining one or more sideboards on each first flange to create one or more support frames to constrain a mirror, one or more extensions including a second tubular element including two second flanges respectively at each end to connect to a respective first flange to extend the second support. A sideboard constrainable to a second flange to create a plurality of frames to constrain the mirrors and widen mirror reflecting surface total extension.

The present invention relates to a modular solar concentrator of the type specified in the preamble of the first claim.

In particular, the present invention relates to a solar concentrator configured to allow the expansion or reduction of its reflecting surface in such a way as to adapt it for various uses and needs.

As known, solar concentrators or solar concentrating systems, also known by the acronym CSP (Concentrating Solar Power), that allow to convert solar energy into thermal and/or electrical energy by exploiting the reflection of sunlight obtained through generally reflective surfaces consisting of mirrors.

Such mirrors can define various shapes and sizes. Among the most used reflectors there are certainly cylindrical reflectors, parabolic reflectors and paraboloid reflectors.

The reflecting surfaces are, therefore, configured to concentrate the sun's rays on a small receiver. The concentration mode, in detail, may depend on the shape of the reflectors which can reflect the solar rays along a linear acquisition zone or along a point-like acquisition zone.

Generally, once the rays are concentrated in the acquisition area, the solar radiation is converted into electricity and/or the heat is converted into mechanical energy by means of a heat engine, for example consisting of a steam turbine, to whose driving axis is connected to the axis of an electric generator.

In particular, the motor axis and the generator axis can be mutually connected in an integral or proportional manner, for example by means of a mechanical transmission.

In general, reflective surfaces are pre-installed on a frame whose shape and size may vary. Or rather the reflective surface is made from a one piece mirror.

The known art described includes some important drawbacks.

In particular, the reflective surfaces are either small or large for industrial use.

However, the structures are different and, therefore, it is not possible, for example, to convert a small reflective surface for industrial use.

At the most, it is only possible to install a plurality of different reflecting surfaces which, however, are independent of each other.

Furthermore, industrial systems that include large reflective surfaces are difficult to transport. This problem becomes more acute, in detail, especially in the case of off-grid installations that are particularly difficult to reach such as, for example, oases, shelters, isolated tourist facilities, military outposts or more.

In this situation, the technical task underlying the present invention is to devise a modular solar concentrator capable of substantially obviating at least part of the aforementioned drawbacks.

Within the scope of this technical task, it is an important object of the invention to obtain a modular solar concentrator capable of making it possible to realize, at will, systems with small or large reflective surfaces without having to modify the overall structure and without having to add other systems independent in parallel.

Another important object of the invention is to provide a modular solar concentrator capable of facilitating installation even in particularly inaccessible situations such as, for example, the aforementioned off grid installations.

In conclusion, a further aim of the invention is to provide a modular solar concentrator which is versatile and which allows to easily convert systems for domestic use, with small reflecting surfaces, into industrial systems and vice versa.

The technical task and the specified aims are achieved by a modular solar concentrator as claimed in the annexed claim 1.

Preferred technical solutions are highlighted in the dependent claims.

The characteristics and advantages of the invention are clarified below by the detailed description of preferred embodiments of the invention, with reference to the accompanying figures, in which:

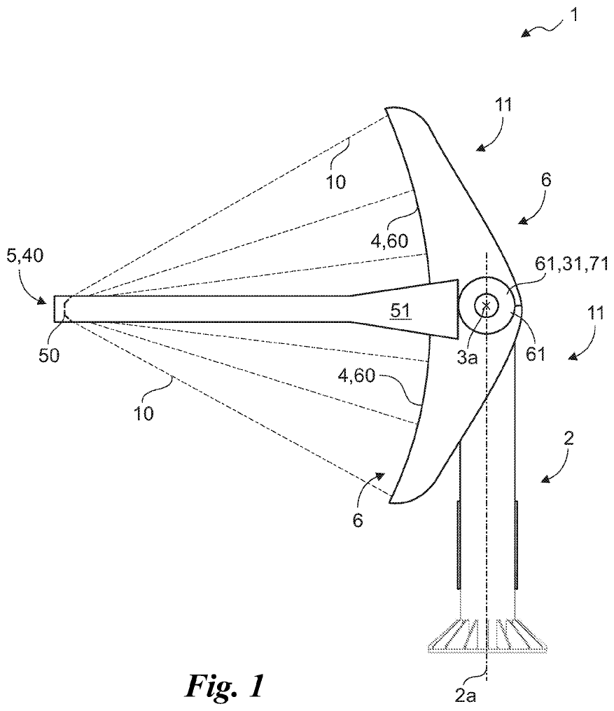

the FIG. 1 shows a side view of a modular solar concentrator according to the invention;

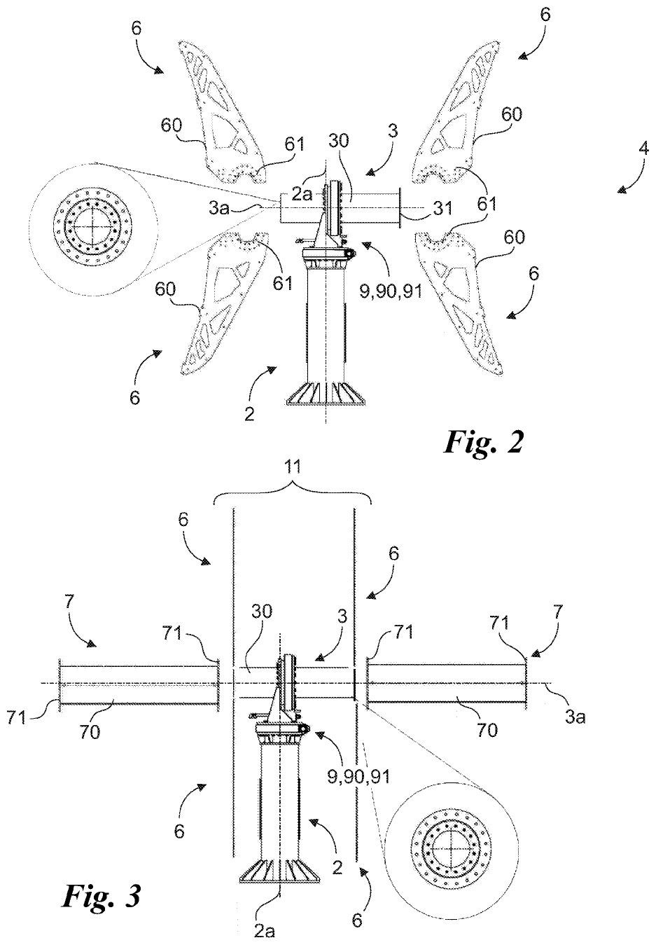

the FIG. 2 illustrates a front view of part of a modular solar concentrator according to the invention during the overlap of the constraint areas on the first flange of the second support;

the FIG. 3 is a front view of part of a modular solar concentrator according to the invention during the arrangement phase of extensions on constraint areas;

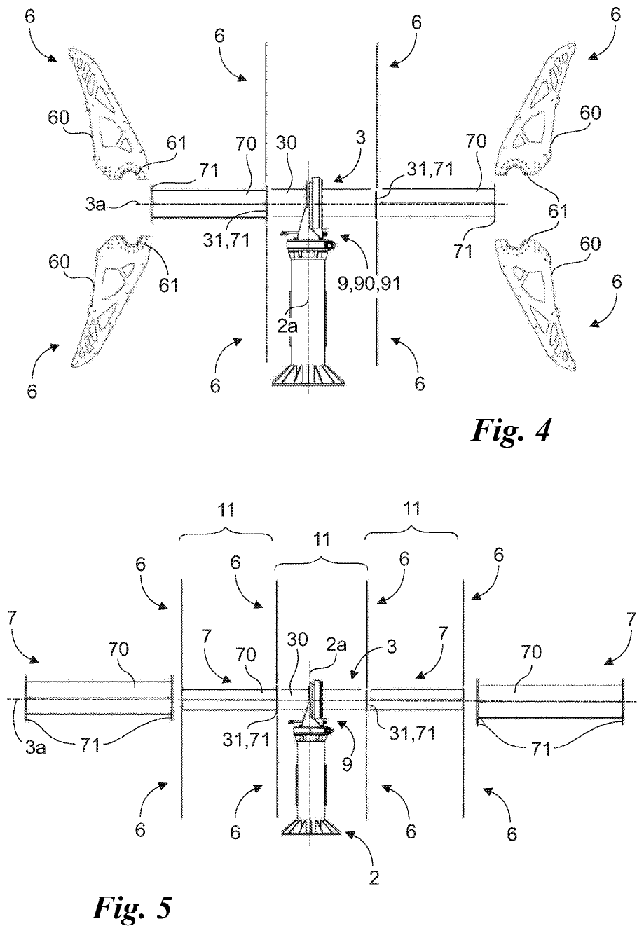

the FIG. 4 is a front view of part of a modular solar concentrator according to the invention during the overlap of the constraint areas on the second flanges of the extensions;

the FIG. 5 shows a front view of part of a modular solar concentrator according to the invention during a further arrangement phase of extensions on constraint areas;

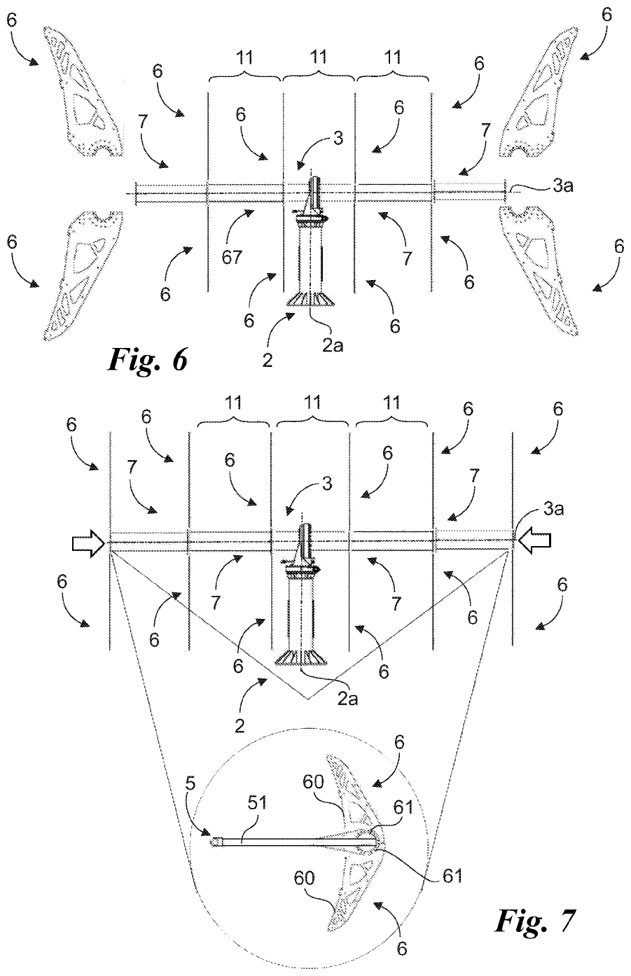

the FIG. 6 illustrates a front view of part of a modular solar concentrator according to the invention during the overlap of the constraint areas on the second flanges of the extensions;

the FIG. 7 is a front view of part of a modular solar concentrator according to the invention during the constraint phase of the connectors on the outer profiles of the sideboards;

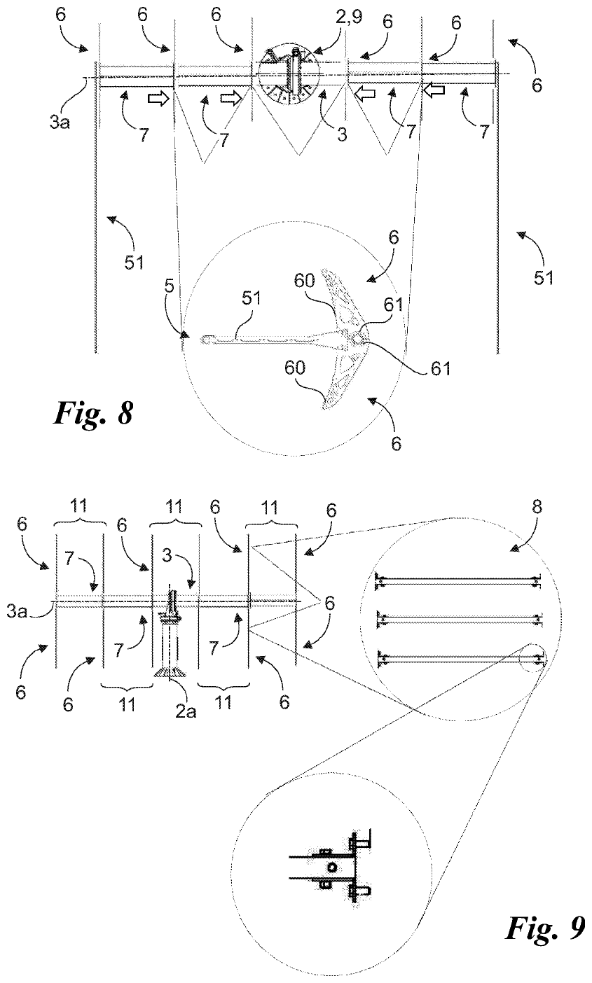

the FIG. 8 is a top view of part of a modular solar concentrator according to the invention during the constraint phase of the connectors on the inner profiles of the sideboards;

the FIG. 9 shows a front view of part of a modular solar concentrator according to the invention during the connection phase of the bars on the profiles;

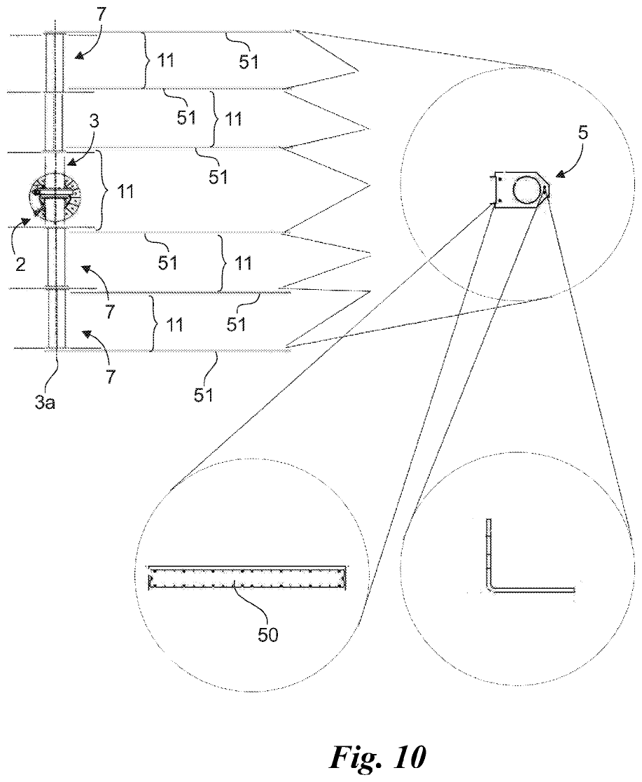

the FIG. 10 illustrates a top view of part of a modular solar concentrator according to the invention during the phase constraint of the acquisition of portions to their respective connectors;

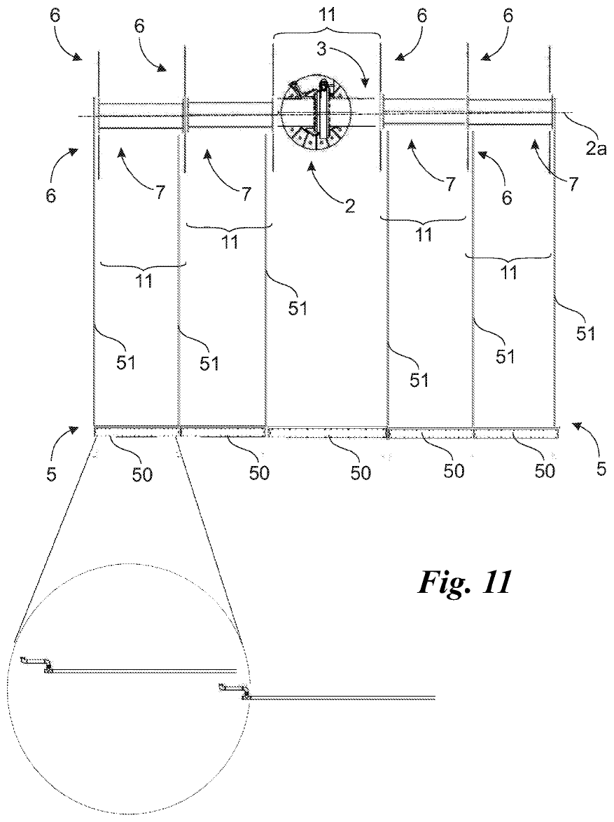

the FIG. 11 is a top view of part of a modular solar concentrator according to the invention during the constraint phase of additional heating elements of the receivers operatively connected to the acquisition portions; and

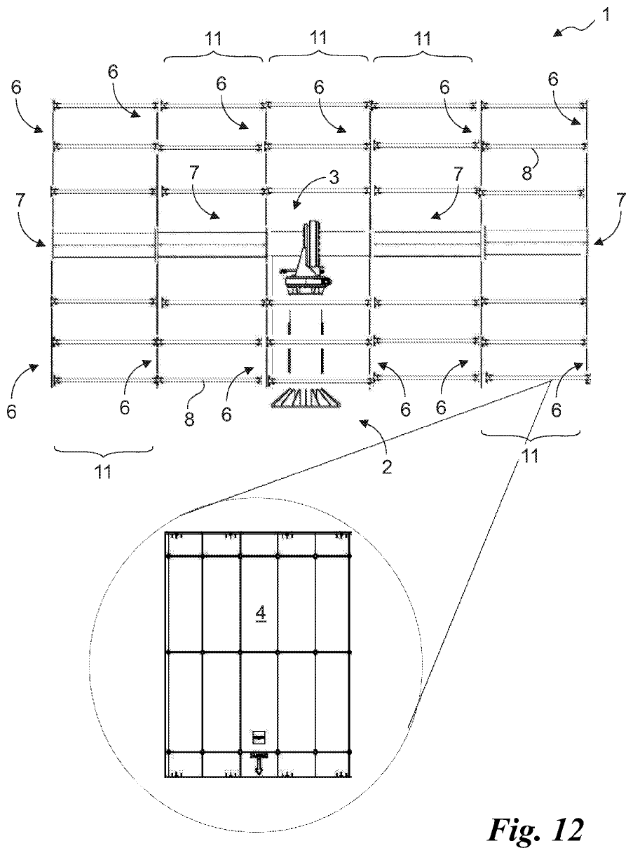

the FIG. 12 is a front view of part of a modular solar concentrator according to the invention prior to the positioning phase of the mirrors on the frames.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the Figures, the modular solar concentrator according to the invention is globally indicated with the number 1.

The concentrator 1 is substantially configured to concentrate solar rays 10 in a predetermined point or zone in such a way as to acquire concentrated solar energy.

In particular, preferably the concentrator 1 comprises a first support 2.

The first support 2 is substantially an element that allows one or more components to be supported in elevation on a ground. Therefore, the support 2 itself is able to be positioned on the ground and, preferably, constrained thereon.

Furthermore, the first support 2 preferably defines a main axis 2a.

The main axis 2a is substantially the prevailing expansion axis of the first support 2.

Therefore, the main axis 2a is able to be transversal with respect to the ground.

Even more in detail, preferably the main axis 2a is perpendicular to the ground.

The first support 2 can therefore substantially be a long object extending along the main axis 2a, for example a cylindrical object such as a pole or a pylon.

The concentrator 1 also comprises at least a second support 3.

The second support 3 is preferably constrained in a compliant way to the first support 2. In particular, preferably, the second support 3 is constrained to the first support 2 in such a way as to determine at least two degrees of freedom with respect to said first support 2.

The second support 3 comprises therefore, a first tubular element 30.

The first tubular element 30 is a preferably hollow element extending along its own axis. Naturally, the first tubular element 30 can define any shape in section, for example square or triangular. Preferably, the first tubular element 30 is cylindrical.

The first tubular element 30 also defines an axis of rotation 3a.

The axis of rotation 3a is preferably transverse with respect to the main axis 2a.

Furthermore, the axis of rotation 3a is the axis around which the second support 3 can rotate with respect to the first support 2. Therefore, the rotation axis 3a defines one of the degrees of freedom of the second support 3.

Furthermore, the second support 3 can rotate with respect to the support 2 also around the main axis 2a. Naturally, the second support 3 could define even a single degree of freedom, preferably around the rotation axis 3a.

The second support 3 further comprises two first flanges 31.

The first flanges 31 are preferably arranged respectively at the ends of the first tubular element 30 along the axis of rotation 3a.

Furthermore, the first flanges 31 are suitable for allowing the connection with other components of the concentrator 1, as better explained subsequently.

The concentrator 1 also comprises one or more solar mirrors 4.

The mirrors 4 substantially define a reflecting surface. Therefore, the mirrors 4 are substantially a reflecting device configured to receive solar rays 10 and reflect them on the basis of predetermined and material-dependent reflection angles.

Reflecting devices for concentrators are well known in the current state of the art.

The mirrors 4 are, in particular, configured to focus solar rays 10 towards a focal zone 40.

The focal zone 40 can vary according to how the mirrors 4 are positioned on the concentrator 1.

In this regard, the concentrator 1 defines one or more frames 11.

The frames 11 are substantially support structures configured to support one or more mirrors 4.

Therefore, the frames 11 can support one or more mirrors 4 defining, as a whole, a concave shape. In this regard, for example, the mirrors are organized to create a reflecting surface with a semicircular section. Or, even more conveniently, the reflecting surface can define a section of parabolic shape.

Therefore, the focal zone 40 can define various shapes. For example, if the section of the reflecting surface is of a semicircular or parabolic shape, the focal zone 40 extends with the same shape along the rotation axis 3a and can be defined by a focusing strip or band.

If, on the other hand, the mirrors 4 define, as a whole, a paraboloid shape, then the focal zone 40 can be substantially localized around a specific point.

The concentrator 1 therefore also comprises one or more receivers 5.

The one or more receivers 5 are substantially configured to acquire the solar rays focused by the one or more mirrors 4.

The receivers 5 are, therefore, arranged in correspondence with the focal zone 40.

The receivers 5 can also extend parallel to the axis of rotation 3a.

Advantageously, the concentrator 1 comprises a plurality of components that can be assembled to allow the creation of reflective surfaces of variable extension at will.

Even more in detail, the concentrator 1 comprises components suitable for making the support frames 11 for the mirrors 4.

The concentrator 1 in fact comprises a plurality of sideboards 6.

The sideboards 6 are substantially shaped elements preferably extending mainly along a plane. Therefore, the sideboards 6 are comparable to shaped panels or plates.

Furthermore, the sideboards 6 each define a profile 60.

The profile 60 is substantially determined by a section plane normal to the rotation axis 3a. Therefore, the profile 60 is substantially defined by the shape of the respective sideboard 6.

Preferably, the profile 60 is concave in shape. In this regard, for example, the profile can be semicircular. Or, even more conveniently, the profile 60 defines a parabolic shape.

Furthermore, each sideboard 6 is adapted to at least partially support one or more mirrors 4 and, in particular, the profile 60 determines the shape of the section of the reflecting surface.

Therefore, the focal zone 40 is preferably determined by the shape of the profile 60.

The sideboards 6 also define a constraint area 61.

The constraint area 61 is a portion of the sideboard 6, preferably of the profile 6, configured to allow one or more sideboards 6 to be constrained on each first flange 31.

The constraint area 61, therefore, preferably defines a circular sector shape. Even more preferably, the constraint area 61 defines a semicircular shape. In this way, above all the tubular element 30 is cylindrical, the sideboards 6 can be constraint to the flanges 31 oriented in any way.

Overall, the sideboards 6 allow one or more frames 11 to be made.

The frames 11 therefore support one or more mirrors 4. In detail, preferably, on each frame 11 it is possible to constrain at least one mirror 4 so that the opposite sides of the mirror 4 follow the profiles 60 of the sideboards 6 to which the mirror 4 is constrained.

Advantageously, moreover, the concentrator 1 comprises one or more extensions 7.

The extensions 7 are substantially components suitable for extending the structure of the concentrator 1 along the axis of rotation 3a.

Therefore, each extension 7 preferably therefore comprises a second tubular element 70.

The second tubular element 70 is a preferably hollow element extending along its own axis. Naturally, the second tubular element 70 can define, like the first tubular element 30, any shape in section, for example square or triangular. Preferably, the second tubular element 70 is also cylindrical. Even more in detail, preferably, the second tubular element 70 defines shapes and dimensions similar or identical to the first tubular element 30.

The second tubular element 70, moreover, is able to be centered with respect to the rotation axis 3a.

Each extension 7 also comprises two second flanges 71.

The second flanges 71 are preferably arranged respectively at the ends of the second tubular element 70 along the axis of rotation 3a.

Furthermore, the second flanges 31 are configured to be connected to a respective first flange 31. In this way, it is possible to extend the second support 3 along the axis of rotation 3a.

The term connection means that the flanges 31, 71 can be directly or indirectly connected to each other. Preferably, the flanges 31, 71 are mutually constrained indirectly by means of the constraint area 61 of the sideboards 6.

In fact, the constraint area 61 of each sideboard 6 constrained between the second support 3 and an extension 7 is substantially trapped between the flanges 31, 71 and the latter are thus connected.

Advantageously, the sideboards 6 can be connected not only to each first flange 31, but also to each second flange 71.

Therefore, one or more sides are substantially connectable to a respective second flange 71 so as to allow a plurality of frames 11 to be made on which constraining said mirrors 4.

The frames 11 are therefore preferably adjacent along the axis of rotation 3a. In this way, it is possible to widen the total extension of the reflecting surfaces of the mirrors 4.

The structure of the frames 11 can be completed with further reinforcing elements.

Furthermore, the frames 11 can preferably include more than two sideboards 6.

Preferably, in a preferred but not exclusive embodiment shown in FIGS. 2-12, the frame 11 can comprise two pairs of sideboards 6.

The two sideboards 6 of each pair are preferably constrained on opposite sides of the first flange 31 and/or of the second flange 71 so that the sideboards 6 are substantially specular with respect to the second support 3.

Furthermore, the pairs of sideboards 6 constrained to the same first flange 31 and/or second flange 71 are mutually spaced from the first tubular element 30 or from the second tubular element 70. Furthermore, the constraint areas 61 are preferably semicircular in in such a way that, when the sideboards 6 are constrained to the same first flange 31 or second flange 71, they substantially completely cover the first flange 31 and/or the second flange 71. Therefore, the tubular elements 30, 70 can be reciprocally connected indirectly by means of the flanges 31, 71 in such a way as to trap the constraint areas 61 of the two sideboards 6 between the flanges 31, 71.

Naturally, the extensions 7 can be constrained to other extensions 7 and, therefore, as shown in FIGS. 5-6 the second flanges 71 of the extensions 7 can be configured to be constrained to the second flanges 71 of another extension 7.

For example, the concentrator 1 can comprise a plurality of bars 8.

The bars 8 are substantially elongated connecting elements that can be constrained between two sideboards 6.

Therefore, the bars 8 are configured to be constrained between two sideboards 6 parallel to the axis of rotation 3a.

In this way, each frame 11 is strengthened.

Naturally, each frame 11 can include a bar 8, or preferably includes a plurality of bars 8.

In particular, each pair of adjacent bars 8 and sideboards 6 can define housing spaces intended to house a single mirror 4.

Furthermore, also the receivers 5 can be made in a modular way.

Preferably, each receiver 5 in fact comprises an acquisition portion 50 and two connectors 51.

The acquisition portion 50 is configured to receive and acquire said solar rays 10 in such a way as to obtain solar energy by converting it into electrical and/or thermal energy.

The acquisition portion 50 can briefly comprise photovoltaic components and/or heat exchangers suitable for storing electrical energy and/or ending with solar rays 10.

Such acquisition portions 50 are, in any case, widely known to the current state of the art.

In particular, normally, the acquisition portion 50 comprises a container inside which the solar rays 10 are focused through, in detail, a conduit converging towards a transparent wall behind which photovoltaic devices are arranged. Furthermore, there may be heat sinks or thermal devices, for example micro-channel heat exchangers, connected to the photovoltaic devices to collect and exploit the accumulated heat.

Furthermore, the acquisition portion 50 is preferably elongated. Therefore, it preferably extends parallel to the axis of rotation 3a.

The connectors 31, on the other hand, are preferably arranged at two opposite ends of the acquisition portion 50. Furthermore, they are configured to be each constrained to a respective sideboard 6.

Furthermore, the connectors 51 preferably extend transversely to the axis of rotation 3a and are configured to keep the acquisition portion 50 spaced apart from the reflecting surface formed by the mirrors 4, or by the profile 60.

Naturally, since the frames 11 are arranged in a row, the adjacent receivers 5 can share the same connector 51. Therefore, for to constrain two acquisition portions 50 to two adjacent frames 11, it is sufficient that three connectors 51 constrained to three sideboards 6 of which the central connector 51 and the central side 6 are in common.

The concentrator 1 can therefore also comprise control means 9.

The control means 9 are preferably configured to move, on command, the second support 3 and, therefore, also the frames 11 relative to the mirrors 4. In particular, the control means 9 control the movement of the second support 3, or of the mirrors 4, with respect to the support 2 about the main axis 2a and about the axis of rotation 3a.

In this regard, preferably, the control means 9 comprise at least one processor 90 and one or more motors 91.

The processor 90 is substantially of the electronic type and allows to acquire, process and forward signals to other components such as, for example, the motors 91 and/or the second support 3 for driving them.

In this sense, the processor 90 can be any electronic controller, possibly also a computer, preferably a PLC.

The motors 91 can be of any type. Preferably, the motors 91 are of the electric type.

Furthermore, the motors 91 are controlled by the computer 90.

Even more in detail, the motors 91 are two in number. Preferably, each of the motors 91 is dedicated to movement around a respective axis 2a, 3a.

This means that the degrees of freedom of the second support 3 and, therefore, of the mirrors 4 are mutually independent.

The operation of the modular solar concentrator 1 previously described in structural terms is substantially similar to the operation of any solar concentrator.

The invention comprises a new process for realization of the concentrator 1.

The process comprises at least one overlapping phase.

In the overlapping phase, the constraint area 61 of at least two sideboards 6 is superimposed on a distinct first flange 31. Furthermore, the constraint areas 6 are constrained to the first flanges 31 so as to integrally constrain the sides 6 to the second support 3 and define at least one frame 11.

Furthermore, the method comprises an arrangement phase.

In the arrangement phase, one or more extensions 7 are preferably arranged centered with respect to the axis of rotation 3a and at least a second flange 71 faces the first flange 31 and connected to it, trapping the constraint area 61 between the second flange 71 and the first flange 31.

Hence, the process comprises a further overlapping phase.

In the further overlapping phase, the constraint area 61 of at least one further edge 6 is superimposed on a second free flange 71. Furthermore, the constraint area 61 is constrained to the second flange 71 so as to firmly constrain the further sideboard 6 to the extension 7 and define at least one further frame 11.

Of course, in particular, the constraint areas 61 can be semicircular.

In addition, therefore, the overlapping phases can include the overlapping of two constraint areas 61 for each first flange 31 and second flange 71 in such a way that the constraint areas 6 completely cover the flanges 31, 71 and that the sideboards 6 extend mirror-like on opposite sides of the second support 3.

The process also comprises a constraint phase.

In the constraint phase, the connector 51 is constrained integrally to each of the sideboards 6. Furthermore, the acquisition portion 50 is constrained to the connectors 51 in such a way as to make the receiver 5.

In addition, the process preferably comprises a connection phase wherein the side panels 6 are mutually connected with one or more bars 8.

Even more in detail, in the connection phase several bars 8 are connected between each pair of sideboards 6.

In conclusion, the procedure comprises a positioning phase wherein one or more mirror 4 are positioned on the frames 11.

In particular, if there are several bars 8 between each pair of sideboards 6, in the positioning phase a mirror 4 is positioned for each space between two bars 8 and two said sideboards 6.

The solar concentrator 1 modular according to the invention achieves important advantages.

In fact, the concentrator 1 allows to realize, at will, systems with reflective surfaces of small or large dimensions without having to modify the overall structure and without having to add other independent systems in parallel.

Consequently, a further advantage of the concentrator 1 is given by the fact that the latter is able to facilitate installation even in particularly impervious situations such as, for example, off-grid installations.

In conclusion, a further advantage of the concentrator 1 is given by the fact that it is versatile and allows to easily convert systems for domestic use, with reflective surfaces of reduced dimensions, into industrial systems and vice versa.

The invention is susceptible of variants falling within the scope of the inventive concept defined by the claims.

In this context, all the details can be replaced by equivalent elements and the materials, shapes and dimensions can be any.

1. A modular solar concentrator comprising:
a first support defining a main axis transversal to a ground,
at least a second support constrained in a complaint way to said first support and including a first tubular element defining an axis of rotation transversal to said main axis around which said second support can rotate with respect to said first support and two first flanges arranged respectively at the ends of said first tubular element along said axis of rotation,
one or more solar mirrors defining a reflecting surface and configured to focus solar rays towards a focal zone,
one or more receivers available in correspondence with said focal zone and configured to acquire solar rays focused by said one or more mirrors,
a plurality of sideboards each defining a profile of concave shape determined by a plane of section normal to said axis of rotation and a constraint area with a circular sector configured to allow one or more said sideboards to be constrained on each said first flange thus to make one or more support frames on which to constrain at least one said mirror so that two opposite sides of said mirror follow said profiles,
one or more extensions including each a second tubular element adapted to be centered with respect to said axis of rotation and including two second flanges arranged respectively at the ends of said second tubular element along said axis of rotation and configured to be connected to a respective said first flange in such a way as to extend said second support, and
one or more of said sideboards can also be compliant to a respective said second flange so as to allow the realization of a plurality of said frames on which to constrain said mirrors and expanding the total extension of said reflecting surfaces of said mirrors.

2. The concentrator according to claim 1, comprising a plurality of bars configured to be placed between two said side sideboards parallel to said axis of rotation in such a way as to strengthen said frame realized from these banks.

3. The concentrator according to claim 1, wherein each frame comprises a plurality of said bars.

4. The concentrator according to claim 1, wherein each said receiver comprises an acquisition portion of said solar rays extending parallel to said axis of rotation and two connectors arranged at two opposite ends of said acquisition portion and configured to be linked each to a respective said sideboards in such a way as to extend transversely to said axis of rotation and maintain said acquisition portion spaced from said reflecting surface made by said mirrors.

5. The concentrator according to claim 1, wherein said second flange of said extensions are configured to be constrained in said second flanges of another said extension.

6. The concentrator according to claim 1, wherein said frame comprises two pairs of said sideboards and two of said sideboards of each of said pairs are constrained on opposite sides of said first flange and/or said second flange so that said sideboards are substantially mirrored with respect to said second support and said pairs are mutually spaced from said first tubular element or said second tubular element.

7. The concentrator according to claim 1, comprising control means configured to move, on command, said second support around said main axis and around said axis of rotation with respect to said first support and comprising at least one processor and one or more motors controlled by said processor.

8. The process for manufacturing a modular solar concentrator according to claim 2, characterized by comprising:
superimposing said constraint area of at least two of said sideboards to a separate said first flange and constraining said constraint areas to said first flanges so as to firmly constrain said sideboards to said second support and define at least one said frame;
arranging one or more said extensions centered with respect to said rotation axis and at least one said second flange facing said first flange and connected thereto, trapping said constraint area between said second flange and said first flange;
further superimpose said constraint area of at least one further said sideboards to a said second free flange and constrain said constraint area to said second flange so as to integrally constrain said further sideboards to said extension and to define at least one further said frame;
constraining at least one said connector integrally to each of said sideboards and said acquisition portion to said connectors in such a way as to realize said receiver;
mutually connecting said sideboards with one or more said bars;
positioning one or more mirrors on said frames.

9. The process according to claim 8, in which said constraint areas are semicircular and in said overlapping steps two of said constraint areas for each of said first flanges and said second flanges in such a way that said constraint areas entirely cover said flanges and said sideboards extend mirror like on opposite sides of said second support.

10. The process according to claim 1, wherein in said connection phase more bars are connected between each pair of said sideboards and in said positioning phase a said mirror is positioned for each space included between two said bars and two said sideboards.

11. The concentrator according to claim 1, wherein one or more of said sideboards is compliant to a respective said second flange so as to allow the realization of a plurality of said frames] on which to constrain said mirrors and expanding the total extension of said reflecting surfaces of said mirrors.

12. The process according to claim 8, wherein each said receiver comprises an acquisition portion of said solar rays extending parallel to said axis of rotation and two connectors arranged at two opposite ends of said acquisition portion and configured to be linked each to a respective said sideboards in such a way as to extend transversely to said axis of rotation and maintain said acquisition portion spaced from said reflecting surface made by said mirrors.
